(19) United States
(12) Patent Application Publication
(10) Pub. No.: US 2008/0012448 A1
(43) Pub. Date: Jan. 17, 2008

(54) Brushless alternator for vehicles

(75) Inventor: Noriyuki Hayashi, Okazaki-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/822,403

(22) Filed: Jul. 5, 2007

(30) Foreign Application Priority Data
Jul. 13, 2006 (JP) 2006-192254

(51) Int. Cl. H02K 1/22

(52) U.S. Cl. 310/263

(57) ABSTRACT

A vehicle brushless alternator includes a magnetic field part having a field coil portion fixed to a rear frame, and pole cores formed with claw-shaped magnetic poles and constituting a rotary part. The rotary part includes a first claw-shaped magnetic pole section fixed to a shaft, and a second claw-shaped magnetic pole section connected to the first claw-shaped magnetic pole section via a nonmagnetic member. The second claw-shaped magnetic pole section is rotatably supported on the rear frame via a bearing. A boss forms part of a magnetic path of magnetic flux on a radial inward side of the first and second claw-shaped magnetic pole sections and is formed by a portion of the magnetic field part fixed to the rear frame.

### CROSS REFERENCE TO RELATED APPLICATION

The present application is based on and claims priority from Japanese Patent Application No. 2006-192254, filed Jul. 13, 2006, the content of which is incorporated herein by reference.

### BACKGROUND OF THE INVENTION

1. Field of the Invention

The present invention relates to a brushless alternator for vehicles such as cars, trucks and the like.

2. Description of the Related Art

Conventionally, an alternator for vehicles generally comprises a stator, a rotor, a frame and a rectifier. The rotor is driven for rotation by an engine of the vehicle via a shaft, pulleys and a belt. As loads on the vehicle increase, the vehicle alternator becomes large in size and weight and an increase in weight of the rotor itself will put undue stress on the engine. Especially, as for the current tendency toward low speed idle and improvements in accelerating performance, an increase in weight or inertial force of the rotor becomes a major issue because of an insufficient engine torque incurred. In order to reduce the weight or inertial force of the rotor, an improvement has been proposed wherein, as shown in Japanese Patent Laid-open Publication (JP-A) No. 2002-315285, a brushless alternator has a stator with a field coil fixed to a frame, and magnetically permeable rotary claw-shaped pole pieces.

However, due to the rotary pole cores having a cross-sectional shape of cantilevered structure, the conventional brushless alternator suffers from a stability problem at high-speed rotation where flaring and oscillation of the claw-shaped portion become large. As a consequence, a joint portion between the pole cores suffers a large stress and, at worst, the joint may be broken. It is true that the field coil fixed to the frame achieves weight saving. However, due to the existence of a heavy shaft with which the pole cores are press-fitted, sufficient reduction in weight of the entire rotary part or rotor cannot be achieved.

With the foregoing difficulties in view, it is an object of the present invention to provide a brushless alternator for vehicles, which is capable of improving the stability at high-speed rotation and has a rotary part with reduced weight and low inertia.

### SUMMARY OF THE INVENTION

To achieve the foregoing object, the present invention seeks to provide a brushless alternator for a vehicle, comprising a magnetic field part for generating magnetic flux, and an armature for producing an electromotive force in response to the magnetic flux generated by the magnetic field part. The magnetic field part includes a field coil portion with a conductive wire wound thereon and fixed to a rear frame, and pole cores formed with claw-shaped magnetic poles and constituting a rotary part. The rotary part includes a first claw-shaped magnetic pole section fixed to a rotatable shaft, and a second claw-shaped magnetic pole section connected to the first claw-shaped magnetic pole section via a nonmagnetic member. The second claw-shaped magnetic pole section is rotatably supported on the rear frame via a bearing. A boss forms part of a magnetic path of magnetic flux on a radial inward side of the first and second claw-shaped magnetic pole sections and is formed by a portion of the magnetic field part fixed to the rear frame.

With this arrangement, since the pole cores can be supported at respective outer ends in the axial direction of the first and second claw-shaped magnetic pole sections without forming a cantilevered structure, it is possible to limit flaring and oscillation of the claw-shaped magnetic pole sections to thereby improve the stability at high-speed rotation.

Preferably, the shaft is fitted to the first claw-shaped magnetic pole portion and does not project toward the magnetic field part. By virtue of the shaft, which is devoid of rear-side portion for weight reduction, it is readily possible to reduce the weight of the rotary part, which will realize a vehicle brushless alternator with high mechanical response.

In one preferred form of the invention, the magnetic field part has a solid structure at a portion thereof surrounded by the first claw-shaped magnetic pole section. This arrangement enables the field coil portion to have an internal portion filled with a magnetic-flux permeable material, which will increase magnetic field power, leading to increased output power of the brushless alternator. Furthermore, the field coil portion is allowed to have an enlarged winding space, which is effective to further increase the magnetic field power and the resulting output power of the brushless alternator.

Preferably, the second claw-shaped magnetic pole section and the bearing are connected together via a ring-shaped member. This arrangement can readily realize downsizing of the bearing.

The brushless alternator may further comprise a regulator for regulating an output voltage of the brushless alternator in which instance the regulator is preferably disposed in a space surrounded by the first claw-shaped magnetic pole section. With the regulator thus accommodated within the space provided inside the rotary part, a considerable reduction in overall size of the brushless alternator can be attained.

Preferably, the first claw-shaped magnetic pole section surrounds and defines a space that is used as a passage for cooling air. With the cooling air passage thus provided, the magnetic field part now possesses improved cooling capacity and hence is able to provide increased field power, which leads to increased output power of the brushless alternator.

It is preferable that the first claw-shaped magnetic pole section has an end wall extending perpendicular to the axis of the shaft and through-holes formed in the end wall for allowing the cooling air introduced in the space to flow through the through-holes to a front side of the brushless alternator. By virtue of the through-holes provided in the end wall of the front-side pole core, the cooling air is guided to advance along the field coil portion and rotary part of the magnetic field part. This enables the magnetic field part to possess an improved cooling capacity as a whole.

Preferably, the through-holes are formed to skew in a circumferential direction of first claw-shaped magnetic pole section with respect to planes parallel to the axis of the shaft so as to conform to a rotating direction of the first claw-shaped magnetic pole section. By thus skewing the through-holes, the cooling air is allowed to pass through the through-holes with reduced resistance, making it possible to further improve the cooling performance of the magnetic field part.

### BRIEF DESCRIPTION OF THE DRAWINGS

FIG. 1 is an axial cross-sectional view of a vehicle brushless alternator according to one preferred embodiment of the present invention;

FIG. 2 is an axial cross-sectional view showing a modified form of the vehicle brushless alternator according to the present invention;

FIG. 3 is an axial cross-sectional view of a vehicle brushless alternator according to another modification of the present invention;

FIG. 4 is an axial cross-sectional view showing another modified form of the vehicle brushless alternator according to the present invention;

FIG. 5 is an axial cross-sectional view of a vehicle brushless alternator according to still another modification of the present invention; and

FIG. 6 is a right side view of a front-side pole core of the vehicle brushless alternator shown in FIG. 5.

### DETAILED DESCRIPTION OF THE PREFERRED EMBODIMENT

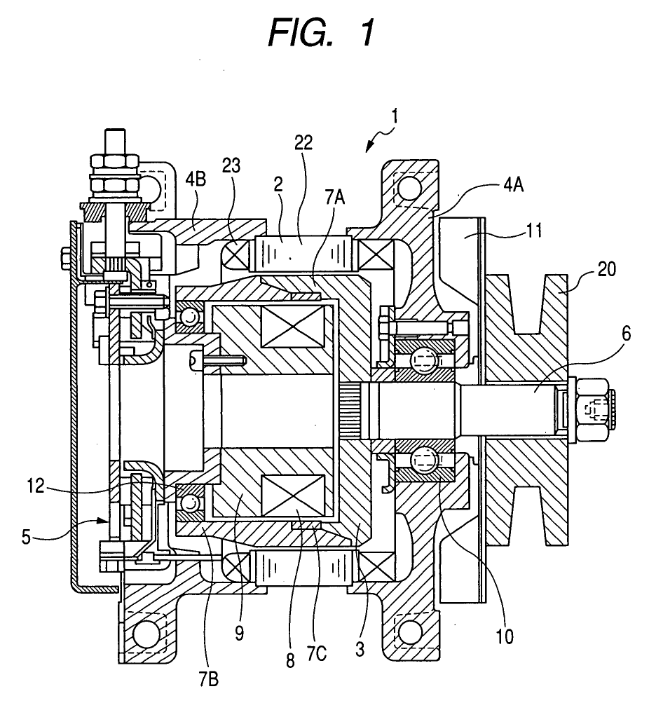

Referring now to the drawings and FIG. 1 in particular, there is shown in axial cross section a vehicle brushless alternator according to a preferred embodiment of the present invention. As shown in FIG. 1, the vehicle brushless alternator 1 generally comprises a stator 2, a rotor 3, a front frame 4A, a rear frame 4B, and a rectifier 5.

The stator 2 is an armature, which produces an electromotive force in response to magnetic flux generated by a magnetic field part (described later), and includes a stator core 22, and a stator winding 23 fitted in slots of the stator core 22.

The rotor 3 is a rotary part rotatable in unison with a shaft 6 and includes a front-side pole core 7A as a first claw-shaped magnetic pole section, a rear-side pole core 7B as a second claw-shaped magnetic pole section, and a nonmagnetic member 7C. The shaft 6 is connected to a pulley 20 and drivable for rotation by an engine (not shown) installed in a vehicle for traveling the same. The rotor 3 will be described in greater detail below. In the illustrated embodiment, a field coil 8 is fixed to the rear frame 4B and not rotatable. Reference numeral 11 denotes a cooling fan fixedly mounted on the shaft 6 in tandem relation to the pulley 20 for cooling the brushless alternator 1 during operation thereof.

The front frame 4A and the rear frame 4B accommodate the stator 2 and the rotor 3. Within the front and rear frames 4A and 4B, the rotor 3 is rotatably supported so that it can rotate about the axis of the shaft 6. The stator 2 is fixed to the front and rear frames 4A and 4B so as to surround the rotor 3 with an inner peripheral surface of the stator 2 facing outer peripheral surfaces of the pole cores 7A and 7B through a predetermined gap (not designated). The front frame 4A and the rear frame 4B are fastened, via the stator 2, to each other by means of a plurality of screw fasteners or bolts (not shown).

The field coil 8 is wound on a boss (stationary yoke) 9. The boss 8 is formed from a magnetic material and forms part of a magnetic path of magnetic flux. The field coil 8 and the boss 9 are fixed to the rear frame 4B. The field coil 8 and the boss 9 together form a field coil portion. The field coil portion, the front-side pole core 7A and the rear-side pole core 7B together form the magnetic field part. The rectifier 5 is connected to an output taking-out end portion of the stator winding 23 and performs three-phase full-wave rectification to convert a three-phase alternating-current (AC) voltage supplied from the stator winding 23, into a direct-current (DC) voltage.

Next, a description will be give about structural details of the rotor 3. The front-side pole core 7A is fixed by press-fit to an end (left end in FIG. 1) of the shaft 6. The shaft 6 extends from a press-fitted part (fixed part) of the front-side pole core 7A only in a rightward direction in FIG. 1 toward a front side (right side in FIG. 1) of the brushless alternator 1. Thus, the shaft 6 is devoid of a rear-side portion, which is present in the shaft of the conventional brushless alternator as a shaft portion extending from the press-fitted part (fixed part) of the front-side pole core 7A in a leftward direction in FIG. 1 toward a rear side (left side in FIG. 1) of the brushless alternator 1. The shaft 6 has an intermediate portion fitted in an inner race of a front-side bearing 10 so that the shaft 6 is rotatably supported by the front frame 4A via the bearing 10. The rear-side pole core 7B and the front-side pole core 7B are connected at their respective claw-shaped portions, via the nonmagnetic member 7C of ring-shaped configuration, by welding. The rear-side pole core 7B has a rear-side end press-fitted to an outer race of a rear-side bearing 12 so that the rear-side pole core 7B is rotatably supported to the rear frame 4B. In the arrangement shown in FIG. 1, the shaft 6 does not have any portion extending from the press-fitting part of the front-side pole core 7A in the leftward direction toward the rear side of the brushless alternator 1. As an alternate arrangement, the shaft 6 may have a portion projecting to a limited extent from the press-fitting part of the front-side pole core 7A toward the rear side of the alternator 1.

As thus far described, in the vehicle brushless alternator 1 of the illustrated embodiment, the front-side pole core 7A and the rear-side pole core 7B, which are connected together as a single integral unit, are supported at respective outer ends in the axial direction thereof and they do not have a cantilevered structure. It is therefore possible to limit flaring and oscillation of the pole cores 7A and 7B to thereby improve the stability at high-speed rotation. Furthermore, by using the shaft 6 with part removed for weight reduction, it is readily possible to reduce the weight of the rotary part, which will realize a vehicle brushless alternator with high mechanical response. Especially, in case of the shaft 6 of the foregoing embodiment, there is no portion projecting from the press-fitted part (fixed part) of the front-side pole core 7A toward the rear side of the brushless alternator 1. Stated in other words, the shaft 6 does not have a rear-side portion, which would otherwise require support by the rear frame 4B. With this arrangement, a great reduction in weight of the rotary part can be achieved.

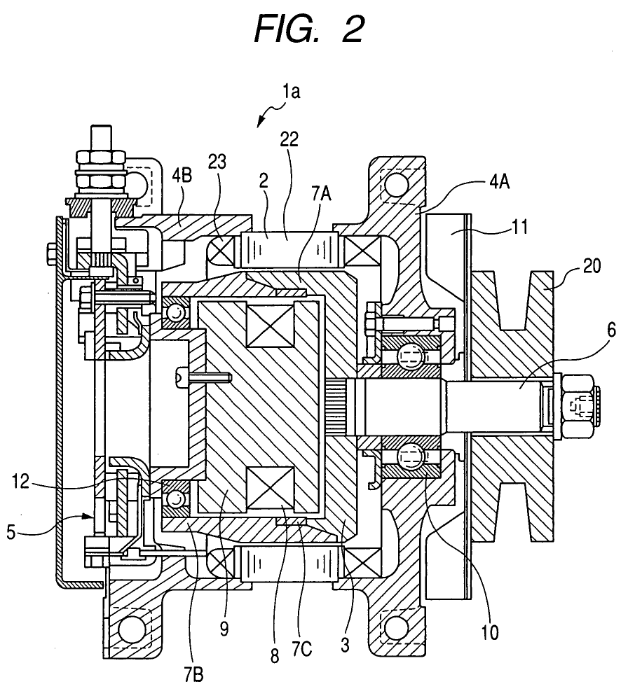

FIG. 2 shows in axial cross section a modified form of the vehicle brushless alternator according to the present invention. The modified brushless alternator 1a includes a field coil portion formed jointly by a field coil 8 and a boss (stationary yoke) 9, the field coil portion being arranged to substantially close or occupy a space that is formed by the shaft 6 devoid of rear-side portion projecting from the press-fitted part of the front-side pole core 7A toward the rear side (left side in FIG. 2) of the alternator 1a. In other words, the field coil portion has a solid structure (with no hollow portion inside the same) at a portion surrounded by the front-side pole core 7A. With this solid structure, the field coil portion is able to have an internal portion filled with a magnetic-flux permeable material, which will increase magnetic field power, leading to increased output power of the brushless alternator 1a. Furthermore, the field coil 8 is allowed to have an enlarged winding space, which is effective to further increase the magnetic field power and the resulting output power of the alternator 1a.

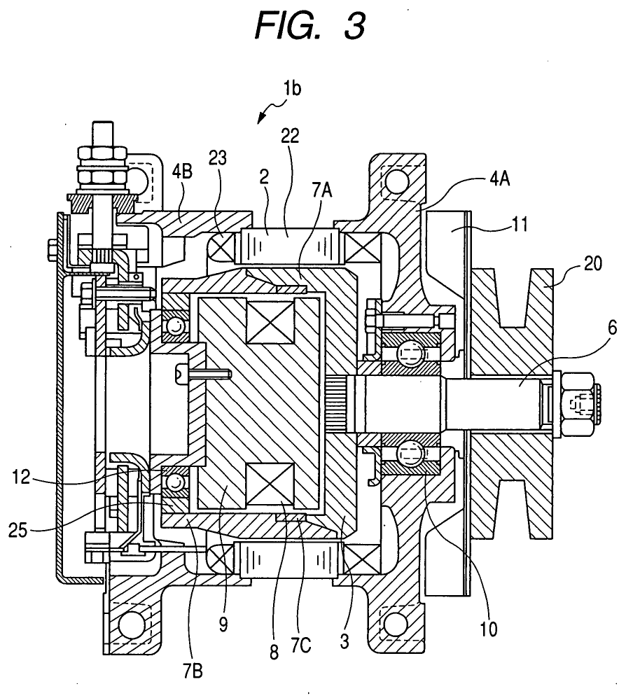

FIG. 3 shows in axial cross section a vehicle brushless alternator 1b according to another modification of the present invention. The modified brushless alternator 1b differs from the alternator 1a of FIG. 2 in that the rear-side pole core 7B and the rear-side bearing 12 are connected to each other via a ring core (ring-shaped member) 25. Since the rear-side bearing 12 is connected to the rear-side pole core 7B not by direct press-fitting engagement but through the intervention of the ring core 25, this arrangement provides a diversity of connecting methods and downsizes the rear-side bearing 12.

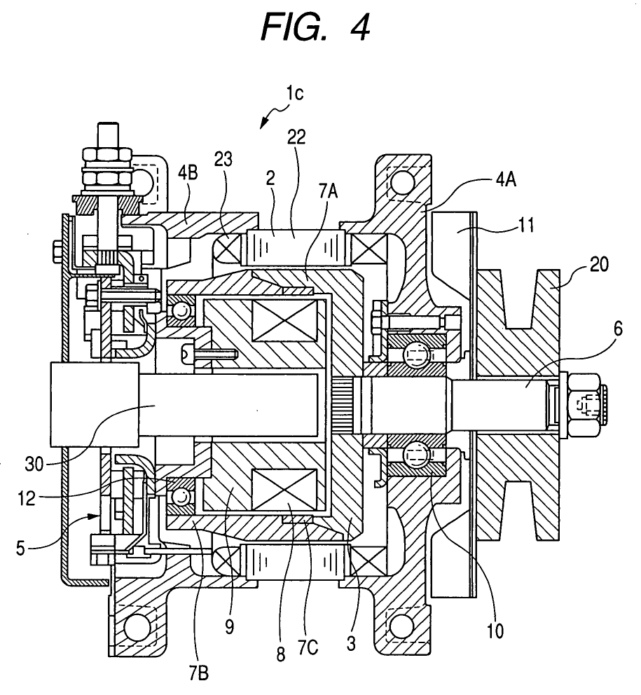

FIG. 4 shows in axial cross section still another modified form of the vehicle brushless alternator. The modified brushless alternator 1c is structurally the same as the brushless alternator 1 of FIG. 1 with the exception that a regulator 30 for regulating output voltage is disposed in a space defined by the shaft 6 which is devoid of portion extending from the press-fitted part (fixed part) of the front-side pole core 7A toward the rear side (left side in FIG. 4) of the alternator 1c. With the regulator 30 thus accommodated within the space provided inside the rotary part, a considerable reduction in overall size of the brushless alternator 1c can be achieved. The space provided inside the rotary part can be used for installation of other components than the regulator 30.

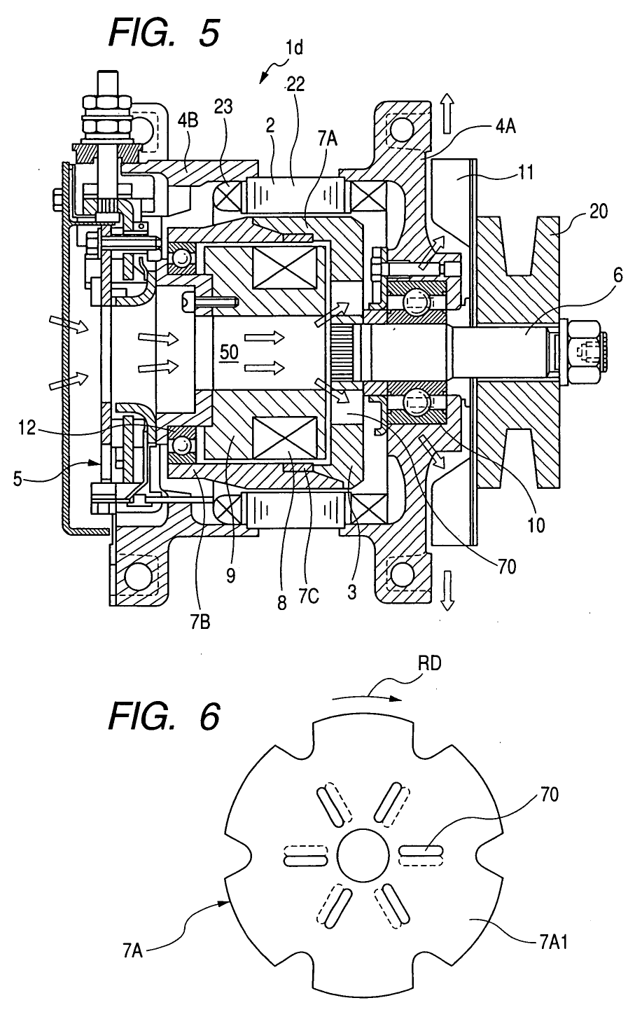

FIG. 5 shows in axial cross section a vehicle brushless alternator 1d according to another modification of the present invention. The modified brushless alternator 1d differs from the alternator 1 of FIG. 1 in that a space formed as a result of the absence of a rear-side portion of the shaft 6 is used as a passage 50 for cooling air. By thus providing the cooling air passage 50, the magnetic field part now possesses improved cooling capacity and hence is able to provide increased field power, which leads to increased output power of the brushless alternator 1d. In FIG. 5 profiled arrows denote a flow of cooling air.

FIG. 6 is a right side view of the front-side pole core 7A looking from a pulley side of the vehicle brushless alternator 1d of FIG. 5. As shown in FIG. 6, the front-side pole core 7A has a plurality of through-holes 70 formed in an end wall 7A1 thereof extending perpendicular to an axis of the shaft 6, so that while the cooling fan 11 (FIG. 5) is rotating, the cooling air is first introduced from the rear side (left side in FIG. 5) of the alternator 1d into the space 50 (that is defined inside the rotary part as a result of the absence of the rear-side portion of the shaft 6), then passes through the through-holes 70 of the front-side pole core 7A, and is finally discharged from the alternator 1d to a front side (right side in FIG. 5) of the alternator 1d, as indicated by the profiled arrows shown in FIG. 5. By thus providing the through-holes 70 in the end wall 7A1 of the front-side pole core 7A, the cooling air is guided to advance along the field coil portion and rotary part of the magnetic field part. This enables the magnetic field part as a whole to possess an improved cooling capacity. As shown in FIG. 6, the through-holes 70 are arranged radially at uniform intervals in the circumferential direction about the center of the end wall 7A1 aligned with the axis of the shaft 6 (FIG. 5). The through-holes 70 have an oblong shape made longer in the radial direction of the front-side pole core 7A than in the circumferential direction. Furthermore, the through-holes 70 are formed to skew in a circumferential direction with respect to planes parallel to the axis of the shaft 6 so as to conform to a rotating direction of the front-side pole core 7A indicated by the arrow RD shown in FIG. 6, so that the cooling air is allowed to pass through the through-holes 70 with reduced resistance, making it possible to further improve the cooling performance of the magnetic field part.

Obviously, various minor changes and modifications are possible in the light of the above teaching. It is to be understood that within the scope of the appended claims the present invention may be practiced otherwise than as specifically described.

What is claimed is:

1. A brushless alternator for a vehicle, comprising:
a magnetic field part for generating magnetic flux;
an armature for producing an electromotive force in response to the magnetic flux generated by the magnetic field part;
a rear frame;
the magnetic field part including a field coil portion with a conductive wire wound thereon and fixed to the rear frame, and pole cores formed with claw-shaped magnetic poles and constituting a rotary part;
the rotary part including a rotatable shaft (6), a first claw-shaped magnetic pole section fixed to the shaft, and a second claw-shaped magnetic pole section connected to the first claw-shaped magnetic pole section via a nonmagnetic member;
the second claw-shaped magnetic pole section being rotatably supported on the rear frame via a bearing; and
a boss forming part of a magnetic path of magnetic flux on a radial inward side of the first and second claw-shaped magnetic pole sections, the boss being formed by a portion of the magnetic field part fixed to the rear frame.

2. A brushless alternator according to claim 1, wherein the shaft is fitted to the first claw-shaped magnetic pole portion and does not project toward the magnetic field part.

3. A brushless alternator according to claim 1, the magnetic field part has a solid structure at a portion thereof surrounded by the first claw-shaped magnetic pole section.

4. A brushless alternator according to claim 1, wherein the second claw-shaped magnetic pole section and the bearing are connected together via a ring-shaped member.

5. A brushless alternator according to claim 1, further comprising a regulator for regulating an output voltage of the brushless alternator, the regulator being disposed in a space surrounded by the first claw-shaped magnetic pole section.

6. A brushless alternator according to claim 1, wherein the first claw-shaped magnetic pole section surrounds and defines a space used as a passage for cooling air.

7. A brushless alternator according to claim 6, wherein the first claw-shaped magnetic pole section has an end wall extending perpendicular to the axis of the shaft and through-holes formed in the end wall of the first claw-shaped magnetic pole section for allowing the cooling air introduced in the space to flow through the through-holes to a front side of the brushless alternator.

8. A brushless alternator according to claim 7, wherein the through-holes are formed to skew in a circumferential direction of first claw-shaped magnetic pole section respect to planes parallel to the axis of the shaft so as to conform to a rotating direction of the first claw-shaped magnetic pole section.
